(19) United States
(12) Patent Application Publication
(10) Pub. No.: US 2021/0080845 A1
(43) Pub. Date: Mar. 18, 2021

(54) TONER, TWO-COMPONENT DEVELOPER, AND IMAGE FORMING APPARATUS

(71) Applicant: SHARP KABUSHIKI KAISHA, Sakai City (JP)

(72) Inventors: YUYA KONDO, Sakai City (JP); YORITAKA TSUBAKI, Sakai City (JP)

(21) Appl. No.: 17/005,317

(22) Filed: Aug. 28, 2020

(30) Foreign Application Priority Data
Sep. 13, 2019 (JP) 2019-167484

(51) Int. Cl. G03G 9/087; G03G 9/097; G03G 9/08; C08G 63/183

(52) U.S. Cl. CPC G03G 9/08755; G03G 9/09791; G03G 2215/0607; C08G 63/183; G03G 9/0819

(57) ABSTRACT

A toner includes toner particles including an amorphous polyester resin and a crystalline polyester resin. In the toner, the toner particles include metallic soap, and SPa [(cal/cm³)^{1/2}] being the SP value (solubility parameter) of the amorphous polyester resin and SPb [(cal/cm³)^{1/2}] being the SP value of the crystalline polyester resin satisfy the relationship, 0.9≤SPa−SPb≤1.8. A two-component developer includes the toner and a carrier. An image forming apparatus is used with the two-component developer.

### BACKGROUND OF THE INVENTION

### Field of the Invention

The present invention relates to a toner including toner particles including an amorphous polyester resin and a crystalline polyester resin, and a two-component developer.

### Description of the Background Art

In some of toners (electrophotographic toners) used in image forming apparatuses such as copying machines, multifunction machines, printers, and facsimile devices that use electrophotography, to achieve both heat resistant storage stability and low temperature fixability required to achieve energy saving in the image forming apparatus, toner particles are provided by heating an amorphous polyester resin and a crystalline polyester resin to melt and knead them, and pulverizing the resulting melt-kneaded material (see, for example, Japanese Unexamined Patent Application Publication Nos. 2016-42135 and 2012-128040).

However, the toner including the toner particles including an amorphous polyester resin and a crystalline polyester resin has the following drawbacks. FIGS. 8 and 9 are cross-sectional views schematically illustrating cross sections of toners TX and TY for explaining the known drawbacks.

FIG. 8 illustrates a cross section of the non-compatible toner TX. As illustrated in the non-compatible toner TX, if ASP value obtained by subtracting, from SPa being the SP value (solubility parameter) of an amorphous polyester resin QX, SPb being the SP value of a crystalline polyester resin RX is a properly large (i.e., if the difference between SPa and SPb is properly large), the crystalline polyester resin RX is finely dispersed and an appropriately compatible state is achieved. Regarding the physical properties of the toner TX, the glass-transition temperature (Tg) of the amorphous polyester resin QX is slightly low. Since the glass-transition temperature is low, the low temperature fixability is improved, and excellent heat resistant storage stability can also be achieved (because of the finely dispersed state and the glass-transition temperature within an allowable range of heat resistance). If the ASP value is further increased (the difference between SPa and SPb is increased), the dispersion diameter of the crystalline polyester resin RX is increased, the low temperature fixability is not improved, and the heat resistant storage stability is extremely deteriorated. Thus, if the ΔSP value is too large (the difference between SPa and SPb is excessively increased), the heat resistant storage stability also deteriorates. A toner having an appropriately large ΔSP value and the crystalline polyester resin finely dispersed can achieve both low temperature fixability and heat resistant storage stability, but there is limitation in low temperature fixability.

On the other hand, FIG. 9 illustrates a cross section of a compatible toner TY. As illustrated in the compatible toner TY, if the ΔSP value is small (the difference between SPa and SPb is decreased), the amorphous polyester resin QY and the crystalline polyester resin RY are compatible with each other. Regarding the physical properties of the toner TY, the glass-transition temperature is extremely lowered. Thus, the low temperature fixability is improved, but the heat resistant storage stability is deteriorated.

Thus, on object of the present invention is to provide a toner in which an amorphous polyester resin and a crystalline polyester resin are compatible with each other to achieve improved low temperature fixability and heat resistant storage stability is also improved, a two-component developer, and an image forming apparatus.

### SUMMARY OF THE INVENTION

As a result of extensive studies to solve the above problems, the inventors have made the following discovery. In the toner including the toner particles including an amorphous polyester resin and a crystalline polyester resin, if ΔSP obtained by subtracting, from SPa [(cal/cm³)^{1/2}] being the SP value of the amorphous polyester resin, SPb [(cal/cm³)^{1/2}] (hereinafter, the unit of SP value may be omitted) being the SP value of the crystalline polyester resin is above 1.8, then the dispersion diameter of the amorphous polyester resin becomes large, the low temperature fixability cannot be improved, and the heat resistant storage stability deteriorates. Regarding this, if the ΔSP value is 1.8 or less and 0.9 or more, the amorphous polyester resin and the crystalline polyester resin are appropriately compatible with each other. In this case, both low temperature fixability and heat resistant storage stability can be achieved, but there is limitation in low temperature fixability. Thus, in the present invention, the toner particles including an amorphous polyester resin and a crystalline polyester resin contain a metallic soap as a nucleating agent, and this makes it possible to achieve improved low temperature fixability compared to conventional toner particles and both low temperature fixability and heat resistant storage stability can be achieved. If the ΔSP value is less than 0.9, compatibility between the amorphous polyester resin and the crystalline polyester resin becomes excessively high, and thus the effect of the metallic soap may be hindered. Regarding this, if the ΔSP value is set to 0.9 or more and the toner particles including the amorphous polyester resin and the crystalline polyester resin contain the metallic soap, the crystalline polyester resin disperses in the amorphous polyester resin and recrystallization of the crystalline polyester can be promoted. As a result, when the toner is in a normal temperature state where the toner is not heated, the amorphous polyester resin and the crystalline polyester resin can be prevented from being compatible with each other, and on the other hand, when fixation of the toner is performed, the amorphous polyester resin and the crystalline polyester resin can become compatible with each other.

A toner according to the present invention based on such findings includes toner particles including an amorphous polyester resin and a crystalline polyester resin, the toner particles include metallic soap, and SPa [(cal/cm³)^{1/2}] being the SP value (solubility parameter) of the amorphous polyester resin and SPb [(cal/cm³)^{1/2}] being the SP value of the crystalline polyester resin satisfy the relationship, 0.9≤SPa−SPb≤1.8. A two-component developer according to the present invention includes the toner according to the present invention and a carrier. An image forming apparatus according to the present invention is to be used with the two-component developer according to the present invention.

Japanese Unexamined Patent Application Publication No. 2015-118310 describes a toner in which a higher fatty acid metal salt is added as a nucleating agent to toner particles including an amorphous polyester resin and a crystalline polyester resin. The toner described in Japanese Unexamined Patent Application Publication No. 2015-118310 can improve low temperature fixability. However, Japanese Unexamined Patent Application Publication No. 2015-118310 mentions that −1.0≤SPa−SPb≤0.8, rather than 0.9≤SPa−SPb≤1.8.

In the present invention, an amorphous polyester resin and a crystalline polyester resin can be compatible with each other to achieve improved low temperature fixability and heat resistant storage stability can also be improved.

### BRIEF DESCRIPTION OF THE DRAWINGS

FIG. 1 is a cross-sectional view schematically illustrating a toner according to an embodiment;

FIG. 2 is a cross-sectional view schematically illustrating a simplified configuration of an image forming apparatus including a developing device used with a two-component developer according to an embodiment;

FIG. 3 is a cross-sectional view schematically illustrating how a toner including toner particles containing metallic soap is fixed;

FIG. 4 is a table showing evaluation results of Examples 1 to 3 and Comparative Examples 1 to 3;

FIG. 5 is a table showing evaluation results of Examples 4 to 8;

FIG. 6 is a table showing evaluation results of Examples 9 to 13;

FIG. 7 is a table showing evaluation results of Examples 1 and 14;

FIG. 8 is a cross-sectional view schematically illustrating a cross section of a conventional non-compatible toner; and

FIG. 9 is a cross-sectional view schematically illustrating a cross section of a conventional compatible toner.

### DESCRIPTION OF THE PREFERRED EMBODIMENTS

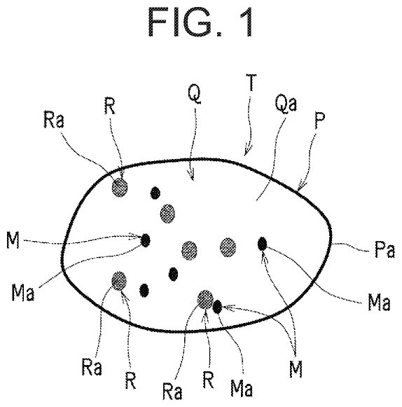

FIG. 1 is a cross-sectional view schematically illustrating toner T according to an embodiment.

As illustrated in FIG. 1, the toner T includes a toner particle P and an external additive (not illustrated) adhered to the surface Pa of the toner particle P. The toner particle P includes an amorphous polyester resin Q, a crystalline polyester resin R, and a metallic soap M. Particles Ra formed of the crystalline polyester resin R and particles Ma formed of the metallic soap M are dispersed in a matrix Qa formed of the amorphous polyester resin Q.

### Toner

The volume average particle diameter of the primary particles of the toner particles P may be, for example, about 4.0 μm to 8.0 μm, but is not limited thereto. The amorphous polyester resin Q and the crystalline polyester resin R are thermoplastic resins. The crystalline polyester resin R is in the form of particles and is dispersed in the matrix Qa formed of the amorphous polyester resin Q.

The amorphous polyester resin can be obtained by polycondensation between a dicarboxylic acid monomer containing terephthalic acid or isophthalic acid as a main component and a diol monomer containing ethylene glycol as a main component.

The crystalline polyester resin can be obtained by polycondensation between a dicarboxylic acid monomer containing an aliphatic dicarboxylic acid having 9 to 22 carbon atoms as a main component and a diol monomer containing an aliphatic diol having 2 to 10 carbon atoms as a main component.

It is preferable that 75 wt % to 85 wt % of the amorphous polyester resin Q is included. It is preferable that 1 wt % to 10 wt % of the crystalline polyester resin R is included. If 1 wt % or more of the crystalline polyester resin R is included, the low temperature fixability can be easily improved. If 10 wt % or less of the crystalline polyester resin R is included, the heat resistant storage stability of the toner T can be easily improved.

The toner particles P may further include a colorant, a charge control agent (CCA), a release agent, and the like, which are not illustrated. The components other than the external additive are collectively referred to as internal additives. As the colorant, organic dyes, organic pigments, inorganic dyes, inorganic pigments and the like used in the field of electrophotography can be used. As the charge control agent, charge control agents for controlling positive charges and controlling negative charges used in the field of electrophotography can be used. Waxes used in the field of electrophotography can be used as the release agent.

### Types of Metallic Soap (Fine Particle Type)

Examples of the metallic soap include zinc stearate, magnesium stearate, and calcium stearate, but are not limited thereto. As for the physical properties, these materials are different mainly in melting point. For example, the melting point of magnesium stearate is 110° C. to 135° C. (average equivalent circle diameter, 3 μm), the melting point of calcium stearate is 155° C. to 165° C. (average equivalent circle diameter, 2 μm), and the melting point of zinc stearate is 125° C. to 135° C. (average equivalent circle diameter, 1.5 μm). Among these, zinc stearate has a good balance between the melting point and the average equivalent circle diameter, and thus the effects of low temperature fixability and heat resistance can easily be exhibited.

### Toner Production Method

The toner T can be produced by a pulverization method. Specifically, the production method of the toner T includes a mixing step, a kneading step, a cooling step, a pulverizing step, a classification step, and an external addition step.

In the mixing step, an amorphous polyester resin, a crystalline polyester resin, a metallic soap and, if necessary, other internal additives are mixed. As a result, a mixture can be obtained. In the kneading step, the mixture is melted and kneaded by using a twin screw kneader to further uniformly disperse the crystalline resin, the metallic soap and other internal additives in the amorphous polyester resin. As a result, a kneaded product can be obtained. In the cooling step, the kneaded product obtained by the melt kneading is cooled and solidified.

In the pulverizing step, the solidified product that has been cooled and solidified is pulverized by a pulverizer. Examples of the pulverizer include a jet mill that performs pulverization by using a supersonic jet stream, and an impact type pulverizer that introduces a solidified product into a space formed between a stator (liner) and a rotor rotating at high speed and pulverizing the solidified product. In the pulverizing step, the average circularity of the toner particles P can be adjusted by appropriately changing the pulverizing conditions. Examples of changing the pulverizing conditions include changing the rotation speed of the rotor of the impact type pulverizer within a range of 1000 rpm to 10000 rpm.

In the classification step, the particle size of the pulverized product is adjusted. As a result, the toner particles P can be obtained. As the classifier, it is possible to use a known classifier that can perform classification by centrifugal force and classification by wind force to remove the over-pulverized toner particles P. For example, a swirling airflow classifier (rotary air classifier) or the like can be used. In the external addition step, external additives are adhered to the toner particles P by mixing the toner particles P and the external additives in a powder mixer such as a Henschel mixer. As a result, the toner T can be obtained. In the external addition step, the adhesion strength of the external additive to the toner particles P can be adjusted by appropriately changing the mixing conditions. Examples of changing the mixing conditions include changing the rotation speed of the stirring blade of the powder mixer within a range of 1000 rpm to 1500 rpm.

### Two-Component Developer

A two-component developer according to an embodiment includes the toner T according to the present embodiment and a carrier (not illustrated). The two-component developer can be produced by mixing the toner T and the carrier using a known mixer. The weight ratio between the toner T and the carrier is not particularly limited, but may be, for example, 3:97 to 12:88.

### Image Forming Apparatus

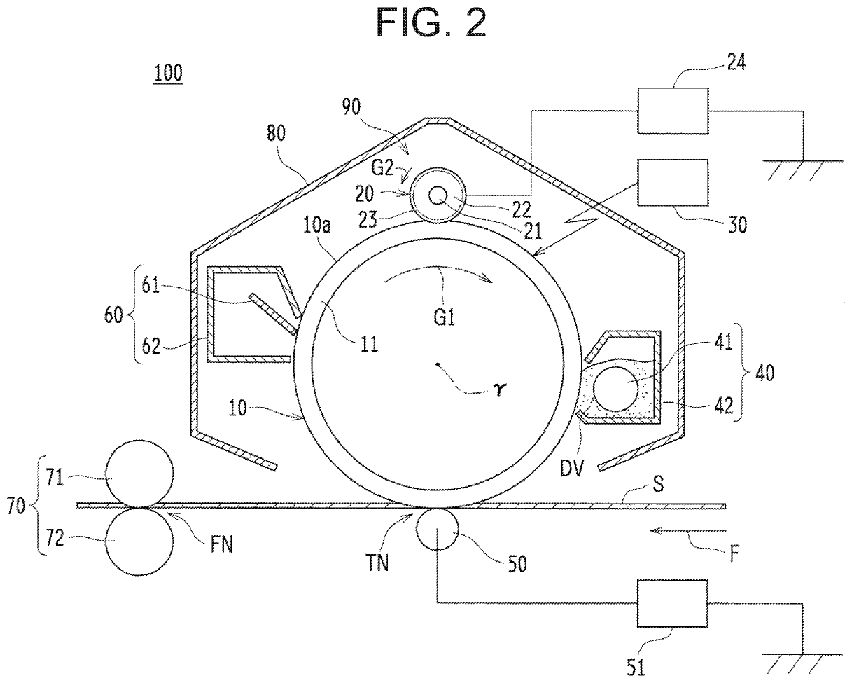

FIG. 2 is a cross-sectional view schematically illustrating a simplified configuration of an image forming apparatus 100 including a developing device 40 used with the two-component developer DV according to the present embodiment.

As illustrated in FIG. 2, the image forming apparatus 100 includes a photosensitive drum 10 that functions as an image carrier, a charging device 90 (a contact type charger), an exposure device 30, the developing device 40, a transfer charging device 50, a cleaning device 60 and a fixing device 70. The charging device 90 charges a surface 10a of the photosensitive drum 10. The exposure device 30 exposes the photosensitive drum 10 charged by the charging device 90 to form an electrostatic latent image. The developing device 40 develops the electrostatic latent image formed by the exposure device 30 to form a toner image. The transfer charging device 50 transfers the toner image formed by the developing device 40 onto a recording medium S such as recording paper. The cleaning device 60 removes and collects the toner remaining on the photosensitive drum 10. The fixing device 70 fixes the toner image transferred by the transfer charging device 50 onto the recording medium S to form an image. In this example, the image forming apparatus 100 is a monochrome printer (specifically, a laser printer). The image forming apparatus 100 may be, for example, an intermediate transfer type color image forming apparatus capable of forming a color image. Although the image forming apparatus 100 is a printer in this example, the image forming apparatus 100 may be, for example, a copying machine, a multifunction machine, or a facsimile device.

The photosensitive drum 10 includes a base body 11 rotatably supported by a main body frame (not illustrated) of the image forming apparatus 100, and is rotationally driven by a driver (not illustrated) about a rotation axis γ and in a predetermined rotation direction G1 (clockwise in the figure).

The charging device 90 includes a charging roller 20 that functions as a charging member. The charging roller 20 is in contact with the surface 10a of the photosensitive drum 10. The charging device 90 uniformly charges the surface 10a of the photosensitive drum 10 to a predetermined potential by a high voltage applying device 24. The charging roller 20 is driven to rotate in a direction G2 opposite to the rotation direction G1 as the photosensitive drum 10 rotates. The charging roller 20 includes a rotation shaft 21, a cylindrical elastic member 22 formed on the rotation shaft 21, and a resistance layer 23 formed on the elastic member 22. For example, the outer diameter of the charging roller 20 may be about 8 mm to about 14 mm, but is not limited thereto. As the rotation shaft 21, for example, a metal material can be used. The elastic member 22 has an appropriate degree of conductivity to secure power supply to the photosensitive drum 10. The resistance layer 23 can adjust the overall electric resistance of the charging roller 20.

The exposure device 30 repeatedly scans, by using light modulated based on image information, the surface 10a of the photosensitive drum 10 being rotationally driven, in the direction of the rotation axis γ of the photosensitive drum 10 that is a main scanning direction. The developing device 40 includes a developing roller 41 and a developing tank 42. The developing roller 41 supplies the two-component developer DV to the surface 10a of the photosensitive drum 10. The developing tank 42 contains the two-component developer DV. The transfer charging device 50 applies a predetermined high voltage to a transfer nip portion TN formed between the photosensitive drum 10 and the transfer charging device 50 and by a high voltage applying device 51. The cleaning device 60 includes a cleaning blade 61 and a recovery casing 62. The cleaning blade 61 removes the toner remaining on the surface 10a of the photosensitive drum 10. The recovery casing 62 receives the toner removed by the cleaning blade 61. The fixing device 70 includes a heating roller 71 and a pressure roller 72. The pressure roller 72 is pressed against the heating roller 71 to form a fixing nip portion FN. The image forming apparatus 100 further includes a housing 80 that accommodates the components of the image forming apparatus 100. A reference sign F in FIG. 2 represents a conveyance direction of the recording medium S.

### Carrier

The carrier is stirred and mixed with the toner T in the developing tank 42 to give the toner T a desired charge. In addition, the carrier functions as an electrode between the developing device 40 and the photosensitive drum 10 illustrated in FIG. 2, to carry the charged toner T to the electrostatic latent image on the photosensitive drum 10 to form a toner image. The carrier is held on the developing roller 41 of the developing device 40 by the magnetic force to be used in developing. After developing, the carrier returns to the developing tank 42 and is stirred and mixed with new toner T again. The carrier is repeatedly used until its life ends.

The carrier includes a carrier core and a resin layer coating the carrier core. The material of carrier core is not particularly limited and any material used in the field of electrophotography can be used. Specific examples of the material of the carrier core include magnetic metals such as iron, copper, nickel and cobalt, and magnetic metal oxides such as ferrite and magnetite. The volume average particle diameter of the carrier core is not particularly limited, but may be, for example, 30 μm to 100 μm. The resin layer preferably includes a silicone resin. The silicone resin can suppress the consumption of the toner T. The resin layer includes a fluororesin. Specific examples of the fluororesin include polytetrafluoroethylene (PTFE), perfluoroalkoxy resin (PFA) and ethylene-tetrafluoroethylene copolymer (ETFE).

### Present Embodiment

In the toner T according to the present embodiment, the toner particles P include the metallic soap M, and SPa [(cal/cm³)^{1/2}] being the SP value of the amorphous polyester resin Q and SPb [(cal/cm³)^{1/2}] being the SP value of the crystalline polyester resin R satisfy the relationship, 0.9≤SPa−SPb≤1.8.

According to the present embodiment, the toner particles P including the amorphous polyester resin Q and the crystalline polyester resin R contain the metallic soap M, and thus when the toner T is in a normal temperature state where the toner T is not heated, the amorphous polyester resin Q and the crystalline polyester resin R can be prevented from being compatible with each other, and on the other hand, when fixation of the toner T is performed, the amorphous polyester resin Q and the crystalline polyester resin R can become compatible with each other. As a result, the low temperature fixability can be improved and the heat resistant storage stability can also be improved.

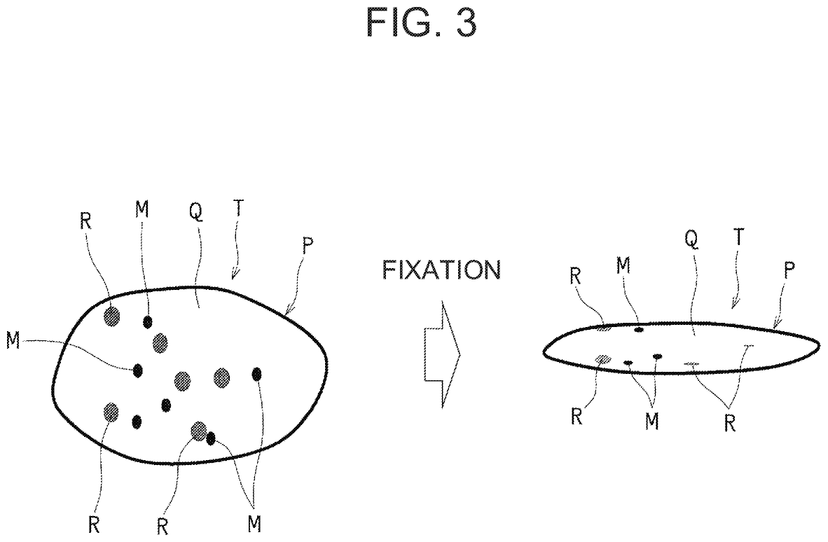

FIG. 3 is a cross-sectional view schematically illustrating how the toner T including the toner particles P containing the metallic soap M is fixed. As illustrated in FIG. 3, if the toner T including the toner particles P containing the metallic soap M is in a normal temperature state, the toner T is in an non-compatible state and thus the heat resistant storage stability can be improved. On the other hand, upon fixation, the amorphous polyester resin Q and the crystalline polyester resin R can become compatible with each other, and thus the low temperature fixability can be improved.

If recrystallization of the crystalline polyester resin R is not promoted, a problem of occurrence of so-called filming, that is a phenomenon in which the melt toner T is adhered to the surface 10a of the photosensitive drum 10 (photoconductor), arises. For example, in a case where the photosensitive drum 10 is charged by the charging device 90 (contact type charger) that comes in contact with the surface 10a of the photosensitive drum 10 to charge the surface 10a of the photosensitive drum 10, scratches are formed on the surface 10a of the photosensitive drum 10 due to pressure applied to the photosensitive drum 10. In this case, the crystalline polyester resin R component is likely to adhere to the surface 10a of the photosensitive drum 10. This problem often arises particularly in the image forming apparatus 100 including the contact type charger as in the present embodiment.

Regarding this, in the present embodiment, recrystallization of the crystalline polyester resin R can be promoted. As a result, occurrence of filming can be suppressed. For example, even in a situation in which pressure is applied to the photosensitive drum 10 by the charging device 90 (contact type charger) and scratches are formed on the surface 10a of the photosensitive drum 10, it is possible to suppress the crystalline polyester resin R component from adhering to the surface 10a of the photosensitive drum 10, and thus to suppress filming. In addition, cleaning performance for the photosensitive drum 10 can be improved by lubricant action of the metallic soap M, and this also makes it possible to suppress filming. These are particularly effective in the image forming apparatus 100 including the contact type charger as in the present embodiment.

If the average dispersion diameter of the metallic soap M in the toner particle P is less than 0.5 μm or more than 2.0 μm, recrystallization of the crystalline polyester resin R is hindered.

Regarding this, in the present embodiment, the average dispersion diameter of the metallic soap M in the toner particle P is in the range of 0.5 μm to 2.0 μm. This makes it possible to promote recrystallization of the crystalline polyester resin R, and thus the heat resistant storage stability can be improved. In addition, it is possible to surely achieve both heat resistant storage stability and low temperature fixability.

In the present embodiment, the addition amount of the metallic soap M with respect to the crystalline polyester resin R is in the range of 5 wt % to 20 wt %. This makes it possible to further promote recrystallization of the crystalline polyester resin R, and thus the heat resistant storage stability can be further improved.

In the present embodiment, the degree of crystallinity of the crystalline polyester resin R in the toner T including the amorphous polyester resin Q, the crystalline polyester resin R, and the nucleating agent (the toner T containing the nucleating agent) is preferably 0.7 to 0.9. If the degree of crystallinity of the crystalline polyester resin R in the toner T including the amorphous polyester resin Q, the crystalline polyester resin R, and the nucleating agent is less than 0.7, recrystallization is hindered and the effect of the nucleating agent is not sufficiently exhibited. On the other hand, if the degree of crystallinity of the crystalline polyester resin R in the toner T including the amorphous polyester resin Q, the crystalline polyester resin R, and the nucleating agent is more than 0.9, such an excessive degree of crystallinity results in increase in the dispersion diameter of the crystalline polyester resin R, and thus the heat resistant storage stability tends to deteriorate.

In the present embodiment, the degree of crystallinity of the crystalline polyester resin R in the toner T including the amorphous polyester resin Q and the crystalline polyester resin R (the toner T containing no nucleating agent) is preferably 0.2 to 0.7. If the degree of crystallinity of the crystalline polyester resin R in the toner T including the amorphous polyester resin Q and the crystalline polyester resin R is less than 0.2, the compatibility becomes too high, and thus even if a nucleating agent is used, it is difficult to expect the effect of recrystallization. If the degree of crystallinity of the crystalline polyester resin R in the toner T including the amorphous polyester resin Q and the crystalline polyester resin R is more than 0.7, recrystallization proceeds even without the nucleating agent. Thus, a nucleating agent is not necessary.

### Measurement Method of Degree of Crystallinity

The endothermic energy of the crystalline polyester resin in the toner is defined as R (J/g). The endothermic energy of the crystalline polyester resin is defined as Q (J/g). If M wt % of the crystalline polyester resin is included in the toner, the degree of crystallinity can be calculated as follows. Here, endothermic energy is measured by using a Differential Scanning calorimeter (DSC).

Degree of crystallinity of crystalline polyester resin in toner=R×100/(M×Q)

### Production Example 1

### Amorphous Polyester Resin A

In Production Example 1, 440 g (2.7 mol) of terephthalic acid, 235 g (1.4 mol) of isophthalic acid, 7 g (0.05 mol) of adipic acid, 554 g (8.9 mol) of ethylene glycol, and 0.5 g of tetrabutoxy titanate as a polymerization catalyst were placed in a reaction chamber, and the mixture was allowed to react for 5 hours in a nitrogen stream at 210° C. while water and ethylene glycol produced were distilled away, and further allowed to react for 1 hour under reduced pressure of 666.7 Pa (5 mmHg) to 2666.4 Pa (20 mmHg). Then, 103 g (0.54 mol) of trimellitic anhydride was added, and the mixture was allowed to react under normal pressure for 1 hour. Then the mixture was allowed to react under reduced pressure of 2666.4 Pa (20 mmHg) to 5332.9 Pa (40 mmHg) and the resin was collected at a predetermined softening point. The amount of collected ethylene glycol was 219 g (3.5 mol). The obtained resin was cooled to room temperature and then pulverized into particles. The resin was named an amorphous polyester resin A. The SP value (SPa) of the amorphous polyester resin A was 11.0.

### Production Example 2

### Amorphous Polyester Resin B

Production Example 2 was conducted in a similar way to Production Example 1. In Production Example 2, the amounts of terephthalic acid, isophthalic acid, adipic acid and ethylene glycol were adjusted to produce an amorphous polyester resin B. The SP value (SPa) of the amorphous polyester resin B was 11.5.

### Production Example 3

### Amorphous Polyester Resin C

Production Example 3 was conducted in a similar way to Production Example 1. In Production Example 3, the amounts of terephthalic acid, isophthalic acid, adipic acid and ethylene glycol were adjusted to produce an amorphous polyester resin C. The SP value (SPa) of the amorphous polyester resin C was 10.5.

### Production Example 4

### Crystalline Polyester Resin A

In Production Example 4, 132 g (1.12 mol) of 1,6-hexanediol, 230 g (1.0 mol) of 1,10-decanedicarboxylic acid, and 3 g of tetrabutoxy titanate as a polymerization catalyst were placed in a reaction chamber, and the mixture was allowed to react for 5 hours under normal pressure at 210° C. while water produced was distilled away. Then, the mixture was continuously allowed to react under reduced pressure of 666.7 Pa (5 mmHg) to 2666.4 Pa (20 mmHg), and the resin was collected when the acid value became 2 mgKOH/g or less. The obtained resin was cooled to room temperature and then pulverized into particles. The resin was named a crystalline polyester resin A. The SP value (SPb) of the crystalline polyester resin A was 9.7.

### Production Example 5

### Crystalline Polyester Resin B

Production Example 5 was conducted in a similar way to Production Example 3. In Production Example 5, the amounts of 1,6-hexanediol, 1,10-decanedicarboxylic acid, and tetrabutoxy titanate as a polymerization catalyst were adjusted to produce a crystalline polyester resin B. The SP value (SPb) of the crystalline polyester resin B was 10.1.

### Production Example 6

### Crystalline Polyester Resin C

Production Example 6 was conducted in a similar way to Production Example 3. In Production Example 6, the amounts of 1,6-hexanediol, 1,10-decanedicarboxylic acid, and tetrabutoxy titanate as a polymerization catalyst were adjusted to produce a crystalline polyester resin C. The SP value (SPb) of the crystalline polyester resin C was 9.1.

### Example 1

Binder resin: Amorphous polyester resin A (glass-transition temperature, 62° C., softening point, 115° C., weight average molecular weight, 65000)
76 wt %

Colorant: Colorant (C.I. Pigment Blue 15:3, manufactured by DIC)
7 wt %

Release agent: Release agent E (ester, melting point, 73° C., NOF Corporation, trade name, WEP3)

Crystalline polyester resin: Crystalline polyester resin A (melting point, 80° C.)
10 wt %

Metallic soap (nucleating agent): Zinc stearate A (NOF Corporation, trade name, MZ-2)
1 wt %

Physical properties of the zinc stearate A: transparent melting point, 120° C., water content, 0.5% or less, metal content, 10.0% to 11.0%, free fatty acid, 0.5% or less

The addition amount of zinc stearate A was 0.5 wt % with respect to the crystalline polyester resin A. The average dispersion diameter of zinc stearate A was 1.5 μm.

The above-mentioned toner raw materials other than the release agent E were premixed for 5 minutes by using a Henschel mixer [manufactured by Mitsui Mining Co., Ltd. (Nippon Coke & Engineering. Co., Ltd. at present), model: FM20C). Then, the mixture was mixed with the release agent E, and melt-kneaded using an open roll continuous kneader (trade name: MOS 320-1800, manufactured by Mitsui Mining Co., Ltd.). The setting conditions of the open roll are as follows: the supply side temperature of the heating roll was 130° C., the discharge side temperature of the heating roll was 100° C., the supply side temperature of the cooling roll was 40° C., and the discharge side temperature of the cooling roll was 25° C. As the heating roll and the cooling roll, rolls having a diameter of 320 mm and an effective length of 1550 mm were used, and the gaps between the rolls at both the supply side and the discharge side were 0.3 mm. The rotation speed of the heating roll was 75 rpm, the rotation speed of the cooling roll was 65 rpm, and the supply amount of the toner raw material was 5.0 kg/h.

The obtained melt-kneaded product was cooled with a cooling belt, coarsely pulverized using a speed mill having a φ2 mm screen, and then finely pulverized using a jet mill (manufactured by Nippon Pneumatic Mfg. Co., Ltd., model: IDS-2). The pulverized product was classified by using an elbow-jet classifier (manufactured by Nittetsu Mining Co., Ltd., model: EJ-LABO) to obtain 6.7 μm toner particles. The ΔSP value (=SPa−SPb), that is calculated by subtracting, from the SP value (SPa=11.0) of the amorphous polyester resin A, the SP value (SPb=9.7) of the crystalline polyester resin A, was 1.3.

### Example 2

Toner particles were produced in the same manner as in Example 1 except that the crystalline polyester resin B was used instead of the crystalline polyester resin A. The ΔSP value (=11.0-10.1) was 0.9.

### Example 3

Toner particles were produced in the same manner as in Example 1 except that the amorphous polyester resin B was used instead of the amorphous polyester resin A. The ΔSP value (=11.5-9.7) was 1.8.

### Example 4

Toner particles were produced in the same manner as in Example 1 except that the kneading temperature was increased by 10° C. The average dispersion diameter of zinc stearate A was 0.7 μm.

### Example 5

Toner particles were obtained in a similar way to Example 1. The average dispersion diameter of zinc stearate A was 0.5 μm.

### Example 6

Toner particles were produced in the same manner as in Example 1 except that zinc stearate B (NOF Corporation, trade name, Zinc Stearate) was used instead of zinc stearate A. The average dispersion diameter of the zinc stearate B was 2.0 μm.

Physical properties of the zinc stearate B: transparent melting point, 116 to 124° C., water content, 0.8% or less, metal content, 10.5% to 11.3%, free fatty acid, 0.5% or less Example 7

Toner particles were produced in the same manner as in Example 1 except that the kneading temperature was decreased by 10° C. The average dispersion diameter of the zinc stearate A was 0.2 μm.

### Example 8

Toner particles were produced in the same manner as in Example 6 except that the kneading temperature was increased by 10° C. The average dispersion diameter of the zinc stearate B was 5.0 μm.

### Example 9

Toner particles were produced in the same manner as in Example 1 except that the addition amount of the zinc stearate A was 10 wt % with respect to the crystalline polyester resin A.

### Example 10

Toner particles were produced in the same manner as in Example 1 except that the addition amount of the zinc stearate A was 5 wt % with respect to the crystalline polyester resin A.

### Example 11

Toner particles were produced in the same manner as in Example 1 except that the addition amount of the zinc stearate A was 20 wt % with respect to the crystalline polyester resin A.

### Example 12

Toner particles were produced in the same manner as in Example 1 except that the addition amount of the zinc stearate A was 1 wt % with respect to the crystalline polyester resin A.

### Example 13

Toner particles were produced in the same manner as in Example 1 except that the addition amount of the zinc stearate A was 30 wt % with respect to the crystalline polyester resin A.

### Example 14

Toner particles were produced in the same manner as in Example 1 except that calcium stearate was used instead of the zinc stearate A.

Metallic Soap (nucleating agent): calcium stearate (NOF Corporation, trade name, MC-2)

Physical properties of calcium stearate: transparent melting point, 160° C., water content, 3.0% or less, metal content, 6.0% to 7.0%, free fatty acid, 0.5% or less Comparative Example 1

Toner particles were produced in the same manner as in Example 1 except that the amorphous polyester resin C was used instead of the amorphous polyester resin A and the zinc stearate A was not added. In this case, the ΔSP value (=10.5-9.7) was 0.8.

### Comparative Example 2

Toner particles were produced in the same manner as in Example 1 except that the amorphous polyester resin C was used instead of the amorphous polyester resin A. In this case, the ΔSP value (=10.5-9.7) was 0.8.

### Comparative Example 3

Toner particles were produced in the same manner as in Example 1 except that the crystalline polyester resin C was used instead of the crystalline polyester resin A. In this case, the ΔSP value was 1.9 (=11.0-9.1).

### Production of Carrier

Next, to 100 parts by weight of a silicone resin (manufactured by Shin-Etsu Chemical Co., Ltd., trade name: KR-251), 10 parts by weight of PTFE (manufactured by Daikin Industries, Ltd., trade name: LDE-410) as fine particles of fluororesin was added to prepare a liquid resin. A carrier core material (manufactured by Dowa IP Creation Co., Ltd.) was dipped into the liquid resin to produce carriers for Examples 1 to 14 and Comparative Examples 1 to 3.

### Production of Two-Component Developer

Two-component developers of Examples 1 to 14 and Comparative Examples 1 to 3 were produced by mixing the above-described toners and the above-described carrier at a mass ratio of 8:92.

### Evaluation

Evaluation of heat resistant storage stability, low temperature fixability and filming for Examples 1 to 14 and Comparative Examples 1 to 3 was performed.

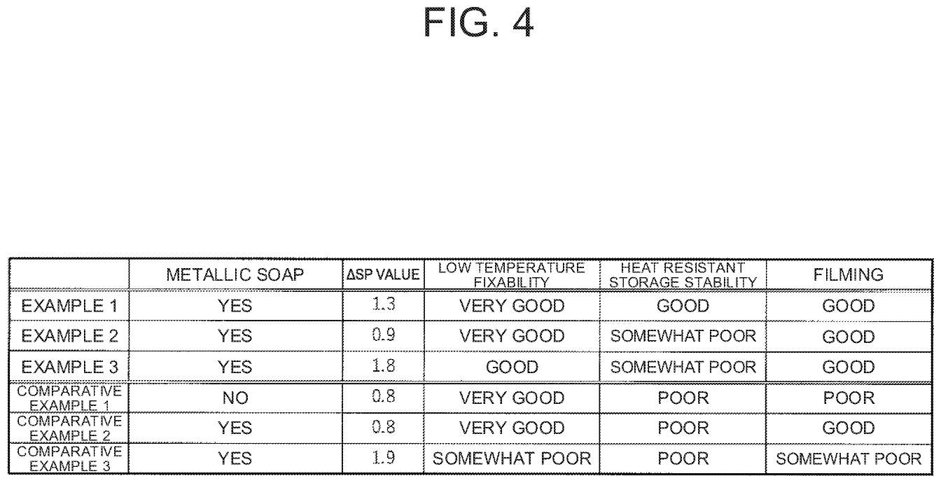

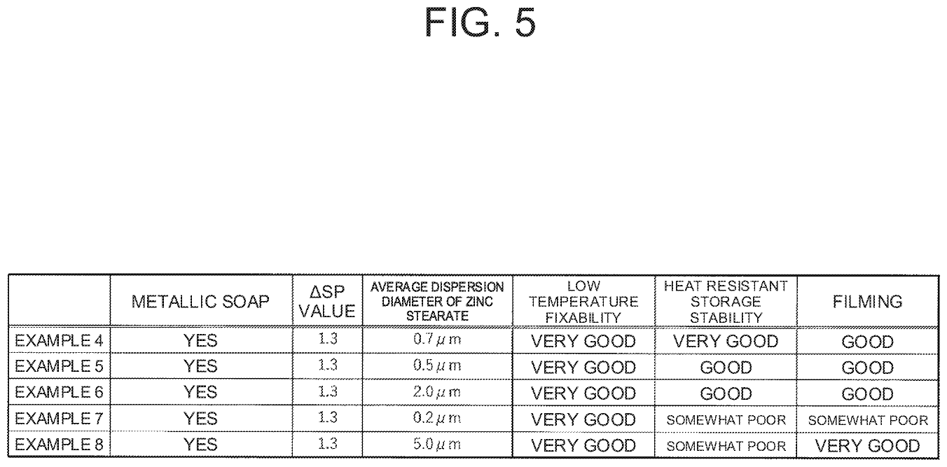

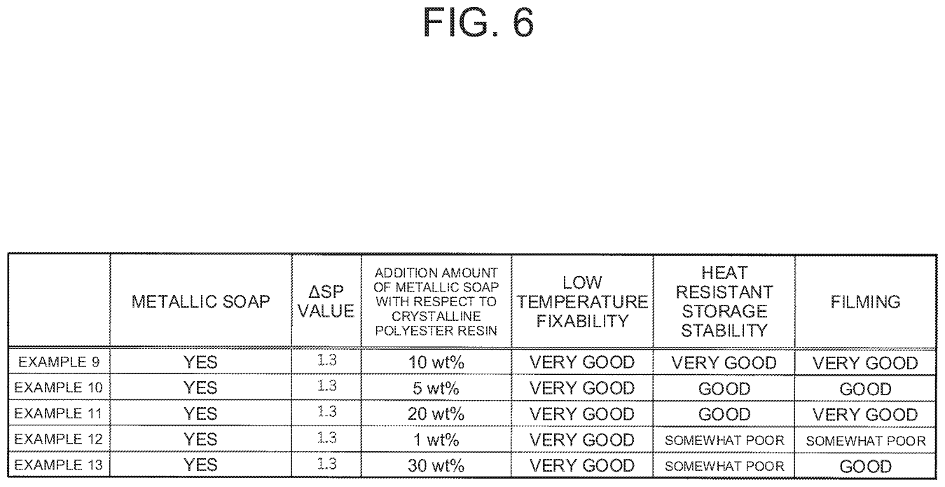

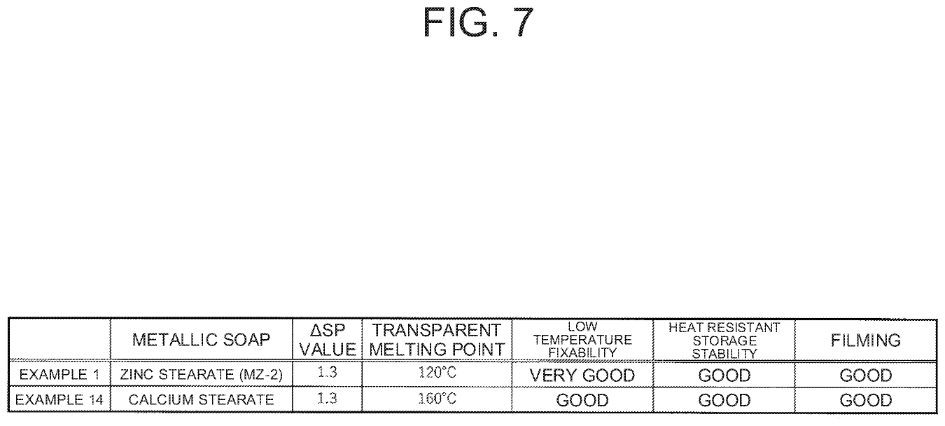

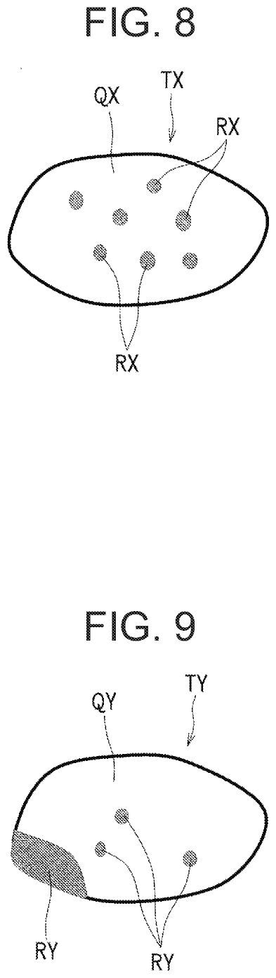

The evaluation results are shown in FIGS. 4 to 7. FIGS. 4 to 7 are tables showing the evaluation results of Examples 1 to 14 and Comparative Examples 1 to 3.

### Measurement of Average Dispersion Diameter of Metallic Soap Dispersed in Toner Particles

The toner particles of Examples and Comparative Examples were embedded in an epoxy resin that is curable at a normal temperature and the epoxy resin was allowed to cure. A cross section of the resulting cured product was exposed by using an ultramicrotome equipped with a diamond blade (manufactured by Reichert, trade name: Ultracut N). The exposed cross section of the toner particles was observed using a scanning transmission electron microscope (manufactured by Hitachi High-Tech Corporation, model: S-4800). A considerable number (200 to 300) of metallic soap particles were randomly extracted from the electron micrograph data, and image analysis was performed using image analysis software (trade name: A-zou kun, Asahi Kasei Engineering Corporation). The average of the dispersion diameters of the considerable number of the metallic soap were calculated to obtain the average dispersion diameter of the metallic soap in the toner particles.

### Evaluation of Heat Resistant Storage Stability

Storage stability was evaluated based on the presence or absence of aggregates after storage at high temperature. In a plastic container, 20 g of the toner was placed and the plastic container was sealed. The toner was left to stand at 50° C. for 72 hours, and then the toner was collected and passed through a 230 (63 μm) mesh sieve. A residual amount, which is the weight of the toner remaining on the sieve, was measured, and a residual ratio [(the residual amount of the toner after 72 hours)/(the total weight of the toner)×100], which is the ratio of the residual amount to the total weight of the toner, was calculated. The residual ratio was rated by using the following evaluation grades. A lower value of the residual rate indicates a lower degree of occurrence of toner blocking.

The evaluation grades for heat resistant storage stability were as follows.

Very good (no aggregation, the residual amount was less than 0.5%)

Good (a very small amount of aggregates, the residual amount is 0.5% or more and less than 2.0%)

Somewhat poor (a small amount of aggregates, the residual amount is 2% or more and less than 10.0%)

Poor (a large amount of aggregates, the residual amount is 10.0% or more)

### Evaluation of Low Temperature Fixability

A developing device and a toner cartridge of a multifunction machine (manufactured by Sharp Corporation, model: MX-6150FN) were filled with the prepared two-component developer and toner, respectively, and the fixing roller temperature in the fixing device was set to 145° C.±1° C. An image sample for fixing strength measurement was prepared at room temperature of 25° C. and humidity of 50%.

The image sample for fixing strength measurement was prepared by copying a document including a solid image part (image density (ID)=1.5), 3 cm on each side, onto a recording sheet (trade name: PPC paper SF-4AM3, manufactured by Sharp Corporation).

The image sample was folded with the solid image part inside, and an 850 g roller was rolled back and forth once on the folding line of the folded sample to apply a constant pressure. As a result, a separation sample in which the toner image was separated at the folded portion was obtained.

The separation sample was unfolded, the separated toner was blown off with an air brush, and the separation width (the maximum width of a white line formed in the folded portion) was measured as an index of fixing strength.

The evaluation grades for low temperature fixability were as follows.

Very good (separation width was less than 0.2 mm)

Good (separation width was 0.2 mm or more and less than 0.3 mm) Somewhat poor (separation width was 0.3 mm or more and less than 0.5 mm)

Poor (separation width was 0.5 mm or more)

### Evaluation of Filming

A color multifunction machine (manufactured by Sharp Corporation, trade name: MX-2640) were filled with the prepared two-component developer and toner, and a continuous print test in which square solid images (ID=1.45 to 1.50), 1 cm on each side, were formed at three positions, which were a central part and both end parts in an axis direction of a developing roller, was performed by using 50000 sheets. Then, a solid image (ID=1.6 to 1.8) was output on an A3 sheet, and the image was visually evaluated.

The evaluation grades for filming were as follows.

Very good (the output solid image was not rough, and melt toner was not adhered to the surface of the photoconductor)

Good (the output solid image was not rough, but a small amount of melt toner was adhered to the surface of the photoconductor)

Somewhat poor (the output solid image was not rough, but melt toner was adhered to the surface of the photoconductor)

Poor (the output solid image was rough, and melt toner was adhered to the surface of the photoconductor)

### Total Evaluation

In Example 1, the amorphous polyester resin and the crystalline polyester resin were appropriately compatible with each other, and the recrystallization of the crystalline polyester resin by the metallic soap was promoted. Example 1 was very good in low temperature fixability, and good in heat resistant storage stability and filming. In Example 2, the SP value was small and the degree of recrystallization of the crystalline polyester resin by the metallic soap was lowered. Thus, Example 2 was very good in low temperature fixability and good in filming, whereas its heat resistant storage stability was somewhat poor. In Example 3, the range of the SP value was large and recrystallization of the crystalline polyester resin by the metallic soap was promoted. Thus, Example 3 was good in low temperature fixability and filming, whereas its heat resistant storage stability was somewhat poor. In addition, the plasticizing ability of the toner was low, and thus the fixability of Example 3 was slightly inferior.

The low temperature fixability of Comparative Example 1 was very good. However, due to the lack of metallic soap, recrystallization of the crystalline polyester resin was not promoted, and thus the heat resistant storage stability of Comparative Example 1 was poor. In addition, the filming of Comparative Example 1 was poor due to the lack of lubricant effect. In Comparative Example 2, the lubricant effect was produced, and thus Comparative Example 2 was very good in low temperature fixability and good in filming. However, due to an excessive degree of compatibility between the amorphous polyester resin and the crystalline polyester resin, recrystallization of the crystalline polyester resin was hindered, and thus the heat resistant storage stability of Comparative Example 2 was poor. In Comparative Example 3, the effect of the metallic soap was small, and thus the amorphous polyester resin and the crystalline polyester resin became non-compatible with each other. As a result, the dispersion diameter of the crystalline polyester resin became large, and thus Comparative Example 3 was somewhat poor in low temperature fixability and filming, and poor in heat resistant storage stability.

In Example 4, an appropriate dispersion diameter of the metallic soap was achieved and recrystallization was easily promoted. Thus, Example 4 was very good in low temperature fixability and heat resistant storage stability, and good in filming. If the dispersion diameter of the metallic soap is small, recrystallization is slightly hindered. However, Example 5 was very good in low temperature fixability, and good in heat resistant storage stability and filming. If the dispersion diameter of the metallic soap is large, recrystallization is slightly hindered. However, Example 6 was very good in low temperature fixability, and good in heat resistant storage stability and filming.

Example 7 was very good in low temperature fixability. However, due to the relatively small dispersion diameter of the metallic soap, the effect of the metallic soap as a nucleating agent was decreased. Thus, Example 7 was somewhat poor in heat resistant storage stability and filming. Example 8 was very good in low temperature fixability and filming. However, due to the relatively large dispersion diameter of the metallic soap, the effect of the metallic soap as a nucleating agent was decreased. Thus, Example 8 was somewhat poor in heat resistant storage stability. In Example 9, the addition amount of the metallic soap was optimal, and recrystallization was promoted. Thus, Example 9 was very good in low temperature fixability, heat resistant storage stability, and filming.

If the addition amount of the metallic soap is small, recrystallization is slightly hindered. However, Example 10 was very good in low temperature fixability, and good in heat resistant storage stability and filming. If the addition amount of the metallic soap was large, recrystallization is slightly hindered. However, Example 11 was very good in low temperature fixability and filming, and good in heat resistant storage stability. Example 12 was very good in low temperature fixability. However, due to the relatively small addition amount of the metallic soap, the effect of the metallic soap as a nucleating agent was decreased. Thus, Example 12 was somewhat poor in heat resistant storage stability and filming.

Example 13 was very good in low temperature fixability and good in filming. However, due to the relatively large addition amount of the metallic soap, the effect of the metallic soap as a nucleating agent was decreased. Thus, Example 13 was somewhat poor in heat resistant storage stability. In Example 1, the melting point of the metallic soap was appropriate, and Example 1 was very good in low temperature fixability, and good in heat resistant storage stability and filming. In Example 14, the melting point of the metallic soap was relatively high, however, Example 14 was good in low temperature fixability, heat resistant storage stability and filming.

The present invention is not limited to the embodiments described above, and can be implemented in various other forms. Thus, the embodiments are merely examples in all respects and should not be interpreted in a limiting manner. The scope of the present invention is defined by the claims, and is not restricted by the description of the specification in any way. All modifications and changes belonging to a scope equivalent to the claims are included within the scope of the present invention.

### DESCRIPTION OF REFERENCE NUMERALS

10 Photosensitive drum
20 Charging roller
40 Developing device (contact type charger)
41 Developing roller
42 Developing tank
70 Fixing device
90 Charging device
100 Image forming apparatus
M Metallic soap
P Toner particles
Q Amorphous polyester resin
R Crystalline polyester resin
T Toner

What is claimed is:

1. A toner comprising toner particles including an amorphous polyester resin and a crystalline polyester resin, wherein
the toner particles include metallic soap, and
SPa [(cal/cm³)^{1/2}] being the SP value (solubility parameter) of the amorphous polyester resin and SPb [(cal/cm³)^{1/2}] being the SP value of the crystalline polyester resin satisfy the following relationship,
0.9≤SPa−SPb≤1.8.

2. The toner according to claim 1, wherein
the average dispersion diameter of the metallic soap in the toner particles is in the range of 0.5 μm to 2.0 μm.

3. The toner according to claim 1, wherein
the addition amount of the metallic soap with respect to the crystalline polyester resin is in the range of 5 wt % to 20 wt %.

4. The toner according to claim 1, wherein
the metallic soap has a melting point of 145° C. or lower.

5. The toner according to claim 1, wherein
the crystalline polyester resin has a degree of crystallinity of 0.2 to 0.7.

6. A two-component developer comprising the toner according to claim 1 and a carrier.

7. An image forming apparatus used with the two-component developer according to claim 6.

8. The image forming apparatus according to claim 7, comprising a contact type charger.
